(19) United States
(12) Patent Application Publication
(10) Pub. No.: US 2021/0312721 A1
(43) Pub. Date: Oct. 7, 2021

(54) REPRODUCTION DEVICE, ANALYSIS ASSISTANCE SYSTEM, AND REPRODUCTION METHOD

(71) Applicant: KOMATSU LTD., Tokyo (JP)

(72) Inventors: Shintaro HAMADA, Tokyo (JP); Yoshiyuki ONISHI, Tokyo (JP); Mitsuhiro AOKI, Tokyo (JP)

(21) Appl. No.: 17/274,221

(22) PCT Filed: Oct. 31, 2019
(86) PCT No.: PCT/JP2019/042720

§ 371 Date: Mar. 8, 2021

(30) Foreign Application Priority Data
Oct. 31, 2018 (JP) 2018-206069

(51) Int. Cl. G07C 3/12; G05B 19/406; E02F 9/26

(52) U.S. Cl. CPC G07C 3/12; G05B 19/406; E02F 9/2004; G05B 2219/2616; E02F 9/26

(57) ABSTRACT

A reproduction device includes an acquisition unit, a reception unit, a reproduction unit, and an estimation unit. The acquisition unit acquires log information of a work machine, which is associated with time. The reception unit receives a reproduction instruction for an operation of the work machine. The reproduction unit reproduces the operation of the work machine, by sequentially applying angle information of the work machine that is included in the log information, to a work machine model in a case of receiving the reproduction instruction. The estimation unit estimates a work content of the work machine at each time, based on the log information.

### CROSS REFERENCE TO RELATED APPLICATION(S)

This application is a U.S. National stage application of International Application No. PCT/JP2019/042720, filed on Oct. 31, 2019. This U.S. National stage application claims priority under 35 U.S.C. § 119(a) to Japanese Patent Application No. 2018-206069, filed in Japan on Oct. 31, 2018, the entire contents of which are hereby incorporated herein by reference.

### BACKGROUND

### Field of the Invention

The present invention relates to a reproduction device, an analysis assistance system, and a reproduction method.

### Background Information

Japanese Unexamined Patent Application, First Publication No. 2016-089388 discloses a work support image generation device that can support work of an operator and generate a support image which includes relative position information between a work machine and a transport vehicle without disposing a dedicated camera-equipped vehicle on a site, and a remote control system of the work machine provided with the work support image generation device.

### SUMMARY

In the field related to the driving and operation of work machines, there are needs such as wanting to look back on one's own operation, wanting to know a movement of a skilled operator, and wanting to know a movement at the time of a breakdown of a work machine or the time of abnormality of the work machine. Therefore, it is required to develop a tool that can analyze a movement of the work machine in detail by faithfully reproducing the movement of the work machine based on an operation of an operator.

In view of the task described above, an object of the present invention is to provide a reproduction device, an analysis assistance system, and a reproduction method in which it is possible to reproduce an operation of a work machine that is a target and estimate a work content to accurately analyze the movement of the work machine after the fact.

According to an aspect of the present invention, there is provided a reproduction device including: an acquisition unit that is configured to acquire log information of a work machine, which is associated with time; a reception unit that is configured to receive a reproduction instruction for an operation of the work machine; a reproduction unit that is configured to reproduce the operation of the work machine by sequentially applying angle information of the work machine that is included in the log information to a work machine model in a case of receiving the reproduction instruction; and an estimation unit that is configured to estimate a work content of the work machine at each time, based on the log information.

According to the above aspect, it is possible to reproduce the operation of the work machine that is a target and estimate the work content to accurately analyze the movement of the work machine.

### BRIEF DESCRIPTION OF DRAWINGS

FIG. 1 is a diagram showing an overall configuration of an analysis assistance system according to a first embodiment.

FIG. 2 is a diagram showing a structure of a work machine according to the first embodiment.

FIG. 3 is a diagram showing a configuration of a cab of the work machine according to the first embodiment.

FIG. 4 is a diagram showing a functional configuration of a reproduction device according to the first embodiment.

FIG. 5 is a diagram showing a processing flow of the reproduction device according to the first embodiment.

FIG. 6 is a first diagram showing an example of log information according to the first embodiment.

FIG. 7 is a second diagram showing an example of the log information according to the first embodiment.

FIG. 8 is a third diagram showing an example of the log information according to the first embodiment.

FIG. 9 is a diagram showing a heat map which is used for estimation of a work content according to the first embodiment.

FIG. 10 is a diagram showing an example of receiving a reproduction scene instruction according to the first embodiment.

FIG. 11 is a diagram showing an example of a work machine model according to the first embodiment.

FIG. 12 is a diagram showing an example of a display image according to the first embodiment.

FIG. 13 is a diagram showing a processing flow of a reproduction device according to a first other embodiment.

FIG. 14 is a diagram showing a processing flow of a reproduction device according to a second other embodiment.

### DETAILED DESCRIPTION OF EMBODIMENT(S)

### First Embodiment

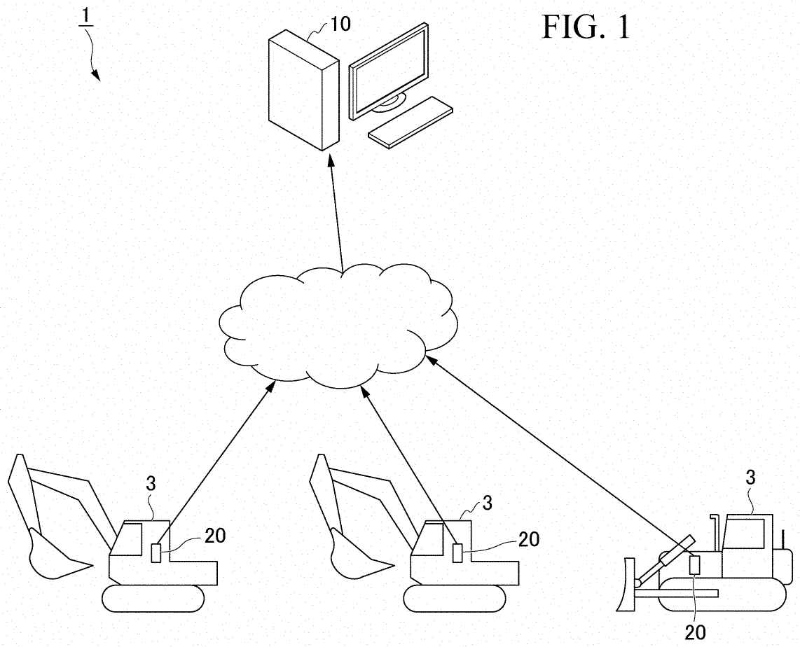

Hereinafter, a reproduction device according to a first embodiment and an analysis assistance system that includes the reproduction device will be described in detail with reference to FIGS. 1 to 10.

### (Overall Configuration of Analysis Assistance System)

FIG. 1 is a diagram showing the overall configuration of the analysis assistance system according to the first embodiment.

An analysis assistance system 1 has a reproduction device 10, and a data logger 20 mounted on each of a plurality of work machines 3.

The work machine 3 is a target of work analysis by the reproduction device 10. As an example of the work machine 3, a hydraulic excavator, a wheel loader, or the like can be given. In the following description, description will be made by taking a hydraulic excavator as an example of the work machine 3. Each work machine 3 is provided with a plurality of sensors. The data logger 20 records and accumulates information indicating the state of the work machine 3 acquired by the sensors, in chronological order. Hereinafter, the information indicating the state of the work machine 3 at each time and recorded by the data logger 20 is also described as log information. In a case where an operating mechanism for operating the work machine 3 is configured to operate the work machine 3 by using an electric operation signal, the information on an operation signal of the work machine 3 may be recorded, accumulated, and included in the log information in chronological order. Further, the data logger 20 transmits the recorded log information to the reproduction device 10 through a wide area communication network at a fixed time interval. The fixed time interval is, for example, a 5-minute interval. The reproduction device 10 records the log information received from the data logger 20 on a recording medium.

The function of the reproduction device 10 will be described later.

### (Structure of Work Machine)

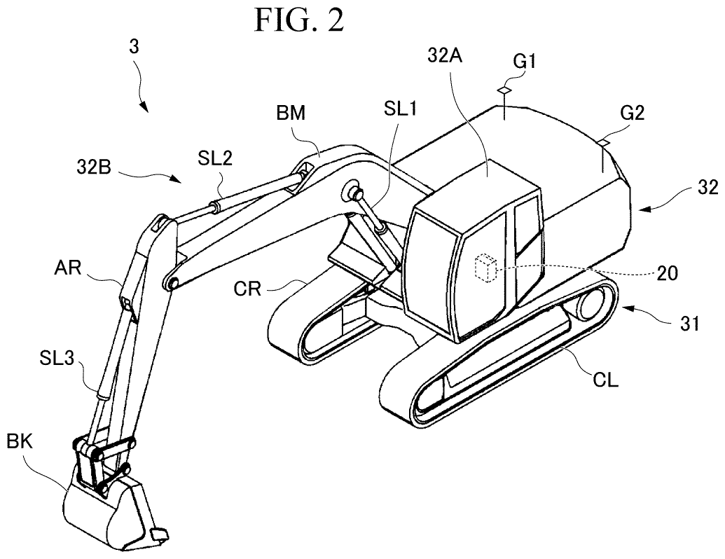

FIG. 2 is a diagram showing the structure of the work machine according to the first embodiment.

The work machine 3 which is a hydraulic excavator excavates and levels earth or the like at a work site or the like.

As shown in FIG. 2, the work machine 3 which is a hydraulic excavator has an undercarriage 31 for traveling, and an upper swing body 32 which is installed at an upper portion of the undercarriage 31 and can be swung. Further, the upper swing body 32 is provided with a cab 32A, work equipment 32B, and two GPS antennas G1 and G2.

The undercarriage 31 has a left crawler CL and a right crawler CR. The work machine 3 moves forward, swings, and moves backward by the rotation of the left crawler CL and the right crawler CR.

The cab 32A is a place where an operator of the work machine 3 gets on board and performs an operation. The cab 32A is installed, for example, at a left side portion of a front end portion of the upper swing body 32. The internal configuration of the cab 32A will be described later.

The work equipment 32B is composed of a boom BM, an arm AR, and a bucket BK. The boom BM is mounted to a front end portion of the upper swing body 32. Further, the arm AR is mounted to the boom BM. Further, the bucket BK is mounted to the arm AR. Further, a boom cylinder SL1 is mounted between the upper swing body 32 and the boom BM. The boom BM can be operated with respect to the upper swing body 32 by driving the boom cylinder SL1. An arm cylinder SL2 is mounted between the boom BM and the arm AR. The arm AR can be operated with respect to the boom BM by driving the arm cylinder SL2. A bucket cylinder SL3 is mounted between the arm AR and the bucket BK. The bucket BK can be operated with respect to the arm AR by driving the bucket cylinder SL3.

The upper swing body 32, the boom BM, the arm AR, and the bucket BK which are included in the work machine 3 which is a hydraulic excavator are one aspect of a movable part of the work machine 3.

### (Configuration of Cab)

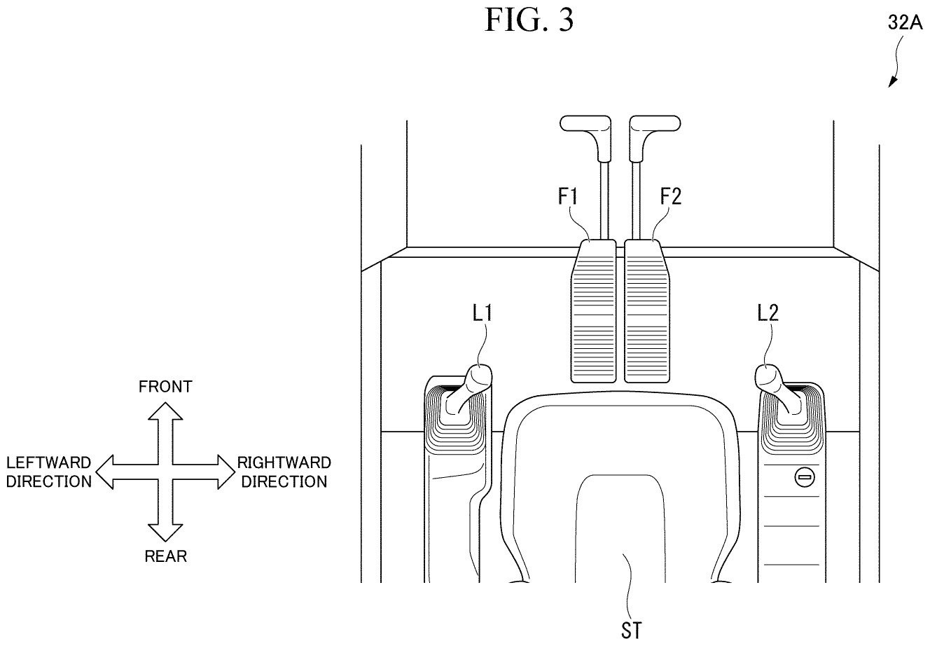

FIG. 3 is a diagram showing the configuration of the cab of the work machine according to the first embodiment.

As shown in FIG. 3, the cab 32A is provided with operating levers L1 and L2, foot pedals F1 and F2, and traveling levers R1 and R2.

The operating lever L1 and the operating lever L2 are disposed on the left and right sides of a seat ST in the cab 32A. Further, the foot pedal F1 and the foot pedal F2 are disposed on a floor surface in front of the seat ST in the cab 32A.

An example of an operation pattern showing a correspondence relationship between an input operation to the operating levers L1 and L2 and the traveling levers R1 and R2 and the operation of the work machine 3 which is a hydraulic excavator is as follows.

The operating lever L1 disposed on the left side when facing the front of the cab is an operating mechanism for performing a swing operation of the upper swing body 32 and excavation and dump operations of the arm AR. Specifically, when the operator of the work machine 3 tilts the operating lever L1 forward, the arm AR performs the dump operation. Further, when the operator of the work machine 3 tilts the operating lever L1 rearward, the arm AR performs the excavation operation. Further, when the operator of the work machine 3 tilts the operating lever L1 in the rightward direction, the upper swing body 32 performs rightward swing. Further, when the operator of the work machine 3 tilts the operating lever L1 in the leftward direction, the upper swing body 32 performs leftward swing. In a case where the operating lever L1 is tilted in a front-rear direction, the upper swing body 32 may perform the rightward swing or the leftward swing, and in a case where the operating lever L1 is tilted in a left-right direction, the arm AR may perform the dump operation or the excavation operation.

The operating lever L2 disposed on the right side when facing the front of the cab is an operating mechanism for performing excavation and dump operation of the bucket BK and raising and lowering operations of the boom BM. Specifically, when the operator of the work machine 3 tilts the operating lever L2 forward, the lowering operation of the boom BM is executed. Further, when the operator of the work machine 3 tilts the operating lever L2 rearward, the raising operation of the boom BM is executed. Further, when the operator of the work machine 3 tilts the operating lever L2 in the rightward direction, the dump operation of the bucket BK is performed. Further, when the operator of the work machine 3 tilts the operating lever L2 in the leftward direction, the excavation operation of the bucket BK is performed.

Further, the traveling levers R1 and R2 are operating mechanisms for performing the operation control of the undercarriage 31, that is, the traveling control of the work machine 3. The traveling lever R1 disposed on the left side when facing the front of the cab corresponds to the rotational drive of the left crawler CL of the undercarriage 31. Specifically, when the operator of the work machine 3 tilts the traveling lever R1 forward, the left crawler CL rotates in a forward movement direction. Further, when the operator of the work machine 3 tilts the traveling lever R1 rearward, the left crawler CL rotates in a backward movement direction.

The traveling lever R2 disposed on the right side when facing the front of the cab corresponds to the rotational drive of the right crawler CR of the undercarriage 31. Specifically, when the operator of the work machine 3 tilts the traveling lever R2 forward, the right crawler CR rotates in the forward movement direction. Further, when the operator of the work machine 3 tilts the traveling lever R2 rearward, the right crawler CR rotates in the backward movement direction. The foot pedals F1 and F2 are interlocked with the traveling levers R1 and R2, respectively, and traveling control can also be performed by the foot pedals F1 and F2.

The operation pattern described above is only an example, and depending on the model or the like of the hydraulic excavator, it is not limited to the above aspect.

Depending on an embodiment, the work machine 3 described using FIG. 2 may not be provided with the GPS antennas G1 and G2.

### (Functional Configuration of Reproduction Device)

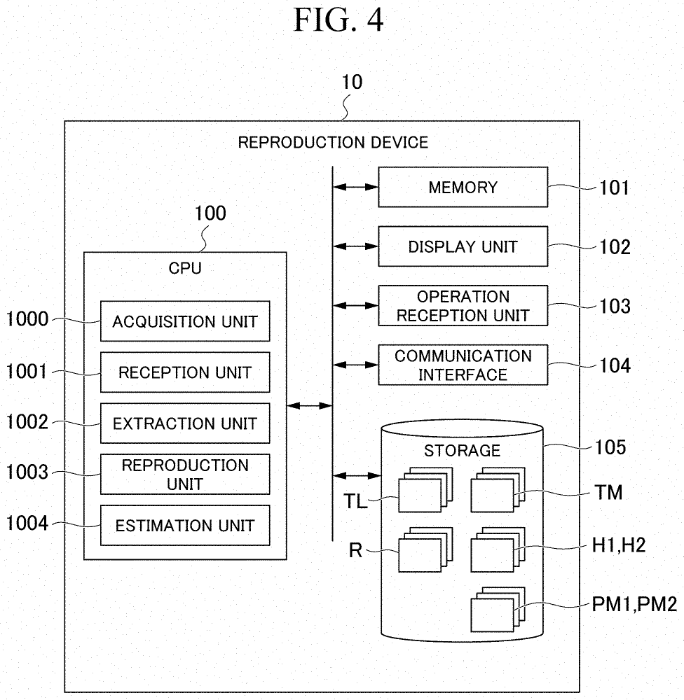

FIG. 4 is a diagram showing the functional configuration of the reproduction device according to the first embodiment.

Hereinafter, the function of the reproduction device 10 according to the first embodiment will be described with reference to FIG. 4.

As shown in FIG. 4, the reproduction device 10 includes a CPU 100, a memory 101, a display unit 102, an operation reception unit 103, a communication interface 104, and a storage 105. The CPU 100 may be a processor such as FPGA or GPU instead of a CPU.

The CPU 100 is a processor that controls the entire operation of the reproduction device 10. Various functions of the CPU 100 will be described later.

The memory 101 is a so-called main storage device. A command and data necessary for the CPU 100 to operate based on a program are loaded in the memory 101.

The display unit 102 is a display device capable of visually displaying information and is, for example, a liquid crystal display, an organic EL display, or the like.

The operation reception unit 103 is an input device and is, for example, a general mouse, keyboard, touch sensor, or the like.

The communication interface 104 is a communication interface for communicating with the data logger 20.

The storage 105 is a so-called auxiliary storage device and is, for example, an HDD (Hard Disk Drive), an SSD (Solid State Drive), or the like. Log information TL received from the data logger 20, a work machine model TM prepared in advance for each the vehicle type and model of the work machine 3, and the like are recorded in the storage 105. The work machine model TM will be described later. Further, a unit work prediction model PM1 and an element work prediction model PM2 which are used when estimating a work content of the work machine 3, heat maps (H1, H2) which are generated in an estimation process, and an estimated work content R of the work machine 3, and the like are also recorded in the storage 105. The unit work prediction model PM1, the element work prediction model PM2, and the heat maps (H1, H2) will be described later.

The functions of the CPU 100 of the reproduction device 10 according to the first embodiment will be described in detail. The CPU 100 operates based on a predetermined program, thereby exhibiting functions as an acquisition unit 1000, a reception unit 1001, an extraction unit 1002, a reproduction unit 1003, and an estimation unit 1004.

The predetermined program may be a program for realizing some of the functions which are exhibited in the reproduction device 10. For example, the program may be a program that exhibits functions by a combination with another program already stored in the storage 105, or a combination with another program mounted on another device. In another embodiment, the reproduction device 10 may include a custom LSI (Large Scale Integrated Circuit) such as a PLD (Programmable Logic Device) in addition to or instead of the above configuration. As an example of the PLD, a PAL (Programmable Array Logic), a GAL (Generic Array Logic), a CPLD (Complex Programmable Logic Device), or an FPGA (Field Programmable Gate Array) can be given. In this case, some or all of the functions which are realized by the processor may be realized by the integrated circuit.

The acquisition unit 1000 acquires the log information TL to be reproduced, from among the plurality of log information TL recorded and accumulated in the storage 105. Here, it is assumed that the plurality of log information TL are recorded in the storage 105 for each file recorded with a different file name.

The reception unit 1001 receives a predetermined reproduction instruction from the operator of the reproduction device 10. For example, the reception unit 1001 receives a reproduction instruction for the work machine 3 from the operator of the reproduction device 10. Further, the reception unit 1001 receives a reproduction scene instruction for providing instructions on a reproduction scene.

The extraction unit 1002 extracts information to be used for reproduction of the work machine 3, from the acquired log information TL.

The reproduction unit 1003 applies the extracted angle information of the work machine 3 to the work machine model TM corresponding to the work machine 3 and reproduces the information.

The estimation unit 1004 estimates the work content of the work machine 3 at each time from the acquired log information TL.

### (Processing Flow of Reproduction Device)

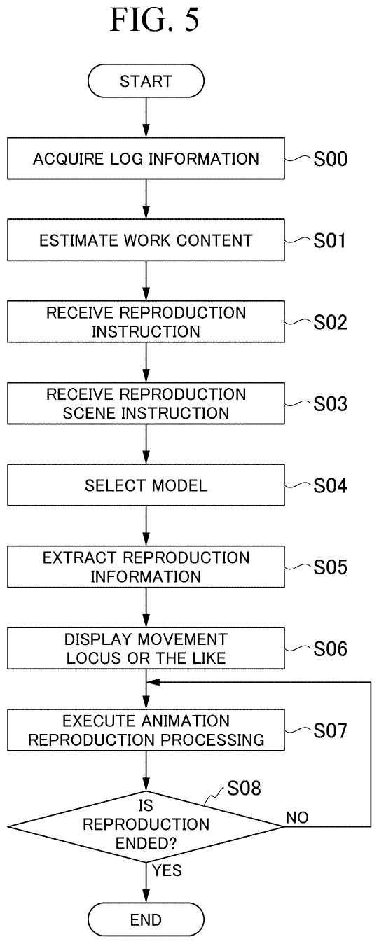

FIG. 5 is a diagram showing a processing flow of the reproduction device according to the first embodiment.

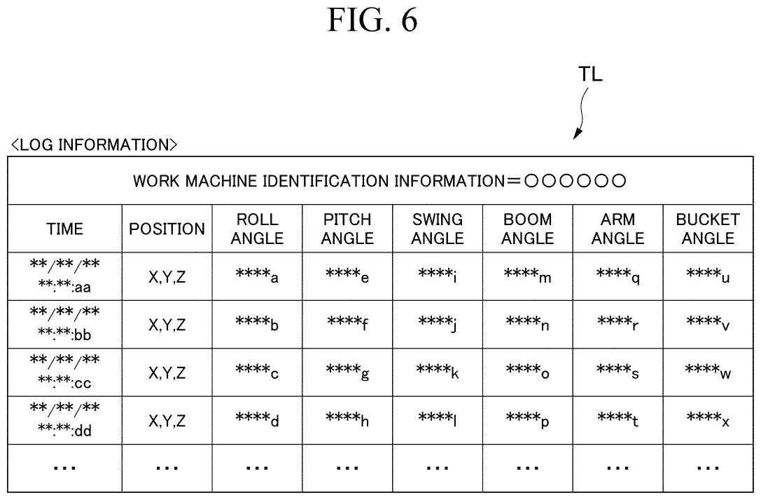

FIGS. 6 to 8 are first to third diagrams showing examples of the log information according to the first embodiment.

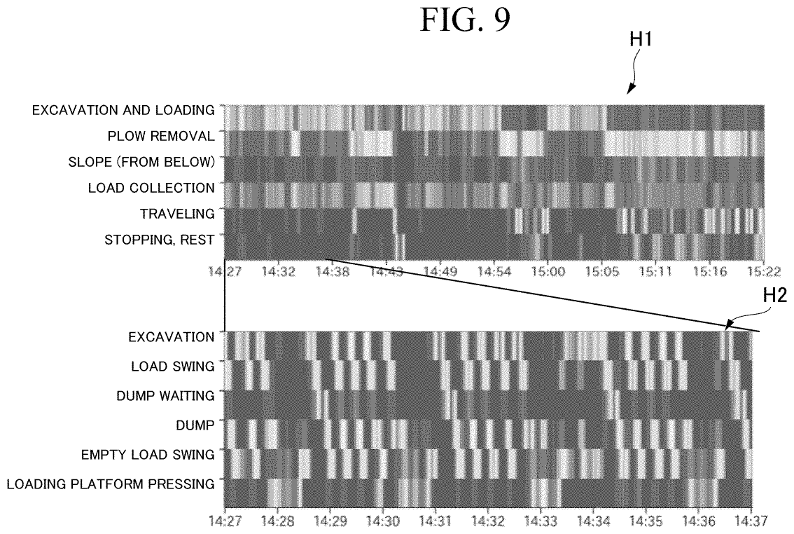

FIG. 9 is a diagram showing the heat map which is used for the estimation of the work content according to the first embodiment.

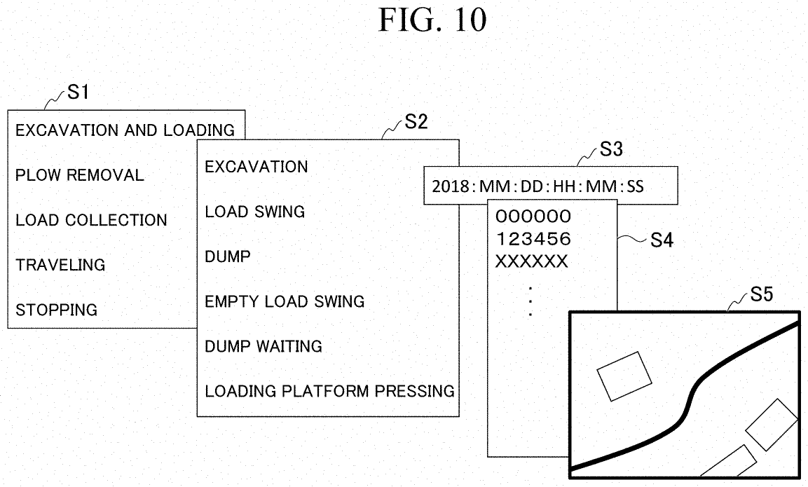

FIG. 10 is a diagram showing an example of receiving the reproduction scene instruction according to the first embodiment.

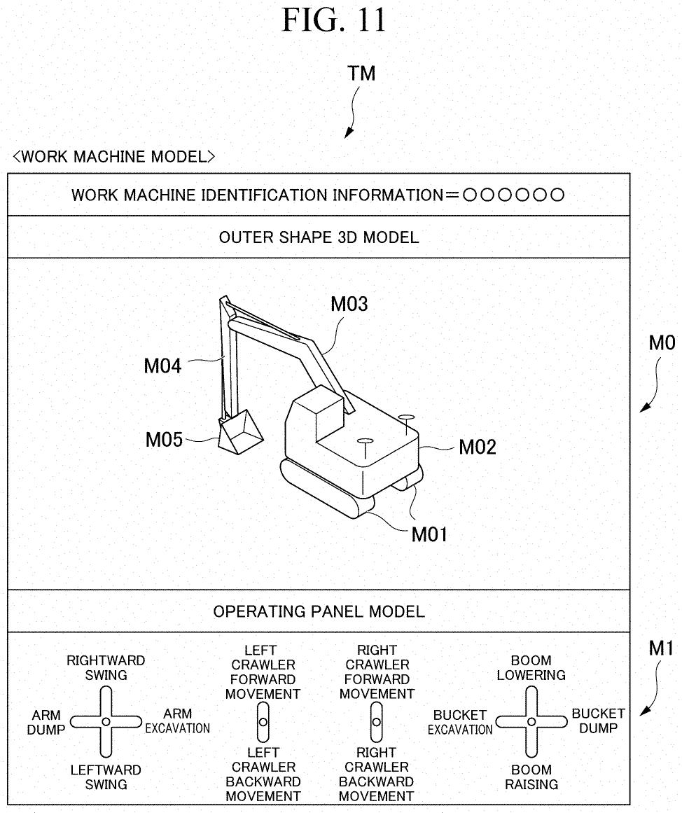

FIG. 11 is a diagram showing an example of the work machine model according to the first embodiment.

Hereinafter, a flow of specific processing which is performed by the reproduction device 10 will be described in detail with reference to FIGS. 5 to 11.

The processing flow shown in FIG. 5 is started from the point in time when a dedicated application is started by the operator of the reproduction device 10.

When the dedicated application is started by the operation of the operator, the acquisition unit 1000 of the CPU 100 loads and acquires all the log information TL to be reproduced, in the memory 101 (step S00).

Here, the log information TL will be described with reference to FIGS. 6 to 8.

As shown in FIGS. 6 to 8, work machine identification information is included in the log information TL. Specifically, the work machine identification information is an individual identification number for individually identifying the work machine 3. In FIGS. 6 to 8, it is assumed that the work machine identification information is assigned so as to correspond to the vehicle type, model, type, machine number, or the like of the work machine 3 representing a hydraulic excavator, a wheel loader, or the like. The work machine identification information may be a number, an alphabetical character, a symbol, a combination thereof, or the like, in addition to the number.

As shown in FIG. 6, information indicating the position or posture of the work machine 3, and angle information of the movable parts of the work machine 3 at each time are included in the log information TL. Specifically, the position of the work machine 3, a roll angle of the work machine 3 which is the tilt of the machine body in the left-right direction, a pitch angle which is the tilt of the machine body in the front-rear direction, a swing angle, a boom angle, an arm angle, and a bucket angle are recorded for each time in the log information TL. Here, the data logger 20 mounted on the work machine 3 specifies and records the position of the work machine 3, based on positioning information which is, for example, information which is obtained by receiving from the GPS antennas G1 and G2, and indicates the latitude and longitude. Further, the data logger 20 calculates and records the roll angle and pitch angle of the work machine 3, based on the measurement result of an IMU (Inertial Measurement Unit) mounted on the work machine 3. Further, the data logger 20 calculates and records the swing angle of the upper swing body 32, based on the positioning information which is obtained from each of the GPS antennas G1 and G2 provided at the upper swing body 32. Further, the data logger 20 calculates and records the boom angle, the arm angle, and the bucket angle, based on the expansion and contraction degrees of the boom cylinder SL1, the arm cylinder SL2, and the bucket cylinder SL3, respectively.

The position, the roll angle, and the pitch angle are information necessary for specifying the position and posture of the work machine 3 itself. Therefore, for example, in an embodiment in which only the movements of the movable parts of the work machine 3, that is, the upper swing body 32, the boom BM, the arm AR, and the bucket BK are reproduced by animation and the position or posture of the work machine 3 itself is not reproduced, the information on the position, the roll angle, and the pitch angle does not need to be included in the log information.

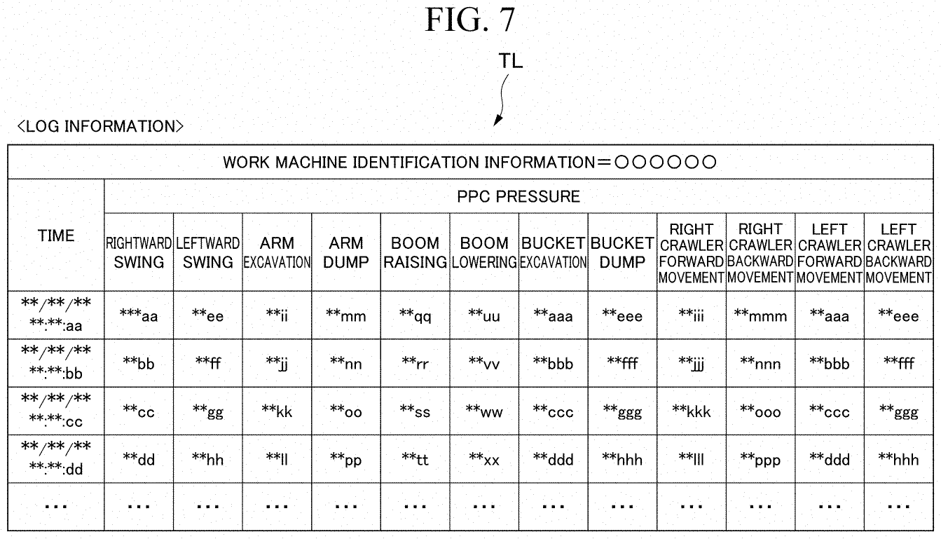

Further, as shown in FIG. 7, a pilot hydraulic pressure (PPC pressure) indicating the degree of input to each of the operating levers L1 and L2 and the like by the operator at each time, that is, the degree of tilt of the lever, and the degree of pedal depression is included in the log information TL. Specifically, the PPC pressures of the operating levers L1 and L2, the traveling levers R1 and R2, or the foot pedals F1 and F2 corresponding to the respective operation types of the leftward/rightward swing, the excavation/dump of the arm, the raising/lowering of the boom, the excavation/dump of the bucket, the forward movement/backward movement of the right crawler, and the forward movement/backward movement of the left crawler by the operator are recorded at each time in the log information TL. Each time shown in FIG. 7 corresponds to each time shown in FIG. 6.

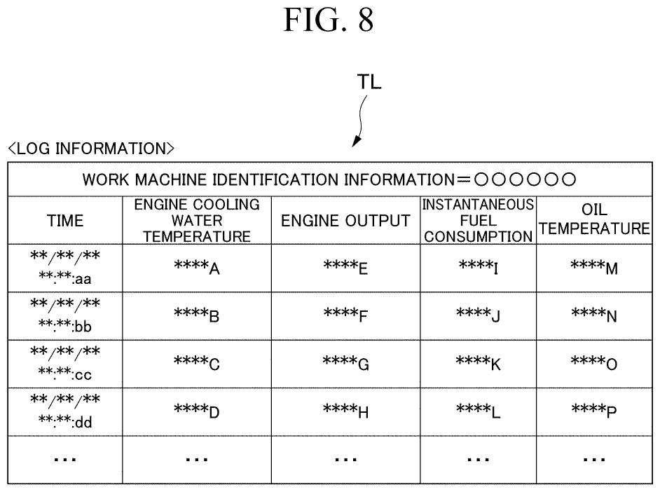

Further, as shown in FIG. 8, information indicating the status of a major drive mechanism such as an engine or a hydraulic pump of the work machine 3 at each time is included in the log information TL. Specifically, an engine cooling water temperature, engine output, an instantaneous fuel consumption, and an oil temperature of the hydraulic pump are recorded for each time in the log information TL. Each time shown in FIG. 8 corresponds to each time shown in FIGS. 6 and 7.

Returning to FIG. 5, the estimation unit 1004 of the CPU 100 estimates the work content of the work machine 3 at each time, based on the acquired log information TL (step S01).

Here, a procedure for the estimation unit 1004 to estimate the work content of the work machine 3 from the log information TL will be described with reference to FIG. 9. The estimation unit 1004 estimates the work content of the work machine 3 with respect to both unit work and element work. The unit work is work that accomplishes one work purpose. The element work is an element constituting the unit work and is work indicating a series of operations or works that are classified by purpose.

As examples of the classification of the unit work, for example, “excavation and loading”, “ditch excavation”, “backfilling”, “plow removal”, “slope (from above)”, “slope (from below)”, “load collection”, “traveling”, and “stopping” can be given.

The excavation and loading is work of digging and scraping earth or rock and loading the scraped earth or rock onto a loading platform of a transport vehicle. The excavation and loading is unit work that is composed of excavation, load swing, dump, empty load swing, dump waiting, and loading platform pressing.

The ditch excavation is work of digging and scraping the ground into a long and narrow groove shape. The ditch excavation is unit work that is composed of excavation, load swing, dump, and empty load swing and may include leveling.

The backfilling is work of putting earth into a groove or hole that has been already formed in the ground and backfilling it flat. The backfilling is unit work that is composed of excavation, load swing, dump, rolling compaction, and empty load swing and may include leveling and brooming.

The plow removal is work of flattening excess undulations of the ground to a predetermined height. The plow removal is unit work that is composed of excavation and dump, or excavation, load swing, dump, and empty load swing and may include leveling and brooming.

The slope (from above) is work of making a slope by the work machine 3 located above a target location. The slope (from above) is unit work that is composed of rolling compaction, excavation, load swing, dump, and empty load swing and may include leveling.

The slope (from below) is work of making a slope by the work machine 3 located below a target location. The slope (from below) is unit work that is composed of rolling compaction, excavation, load swing, dump, and empty load swing and may include leveling.

The load collection is work of collecting earth generated by excavation or the like, before loading it on a transport vehicle. The load collection is unit work that is composed of excavation, load swing, dump, and empty load swing and may include leveling.

The traveling is work of moving the work machine 3. The traveling as the unit work is unit work composed of traveling as the element work.

The stopping is a state where there is no earth and rock in the bucket BK and the work machine 3 is stopped for a predetermined time or longer. The stopping as the unit work is unit work composed of stopping as the element work.

As examples of the classification of the element work, “excavation”, “load swing”, “dump”, “empty load swing”, “dump waiting”, “loading platform pressing”, “rolling compaction”, “leveling”, and “brooming” can be given.

The excavation is work of digging and scraping earth or rock by the bucket BK.

The load swing is work of swinging the upper swing body 32 while holding the scraped earth or rock in the bucket BK.

The dump is work of unloading the scraped earth or rock from the bucket BK to a transport vehicle or a predetermined location.

The empty load swing is work of swinging the upper swing body 32 in a state where there is no earth or rock in the bucket BK.

The dump waiting is work of waiting for a transport vehicle for loading while holding the scraped earth or rock in the bucket BK.

The loading platform pressing is work of pressing and flattening earth loaded on a loading platform of a transport vehicle from above with the bucket BK.

The rolling compaction is work of pushing earth into a turbulent ground with the bucket BK to shape and strengthen the ground.

The leveling is work of leveling earth with the bottom surface of the bucket BK.

The brooming is work of leveling earth with the side surface of the bucket BK.

The estimation unit 1004 obtains a time series of likelihood related to the unit work by inputting the log information TL into the unit work prediction model PM1 in chronological order. The unit work prediction model PM1 is a model that outputs the likelihood related to the unit work when the log information TL is input, by learning using teacher data, and may be stored in the storage 105, for example.

Further, the estimation unit 1004 obtains a time series of likelihoods related to the element work by inputting the log information TL into the element work prediction model PM2 in chronological order. The element work prediction model PM2 is a model that outputs the likelihood related to the element work when the log information TL is input, by learning using teacher data, and may be stored in the storage 105, for example.

The estimation unit 1004 smooths the time series of the likelihood by applying each of the time series of the likelihood related to the unit work and the time series of the likelihood related to the element work to a time average filter, and generates the unit work heat map H1 representing the smoothed time series of the likelihood related to the unit work and the element work heat map H2 representing the smoothed time series of the likelihood related to the element work, as shown in FIG. 9. The heat maps H1 and H2 are maps in which a color representing the likelihood of the classification of the work is given to a plane in which the vertical axis represents the classification of the work and the horizontal axis represents time, based on the smoothed time series of the likelihood. For example, the color related to the heat map may be closer to blue as the likelihood of the classification of the work is lower, and closer to red as the likelihood of the classification of the work is higher. The estimation unit 1004 stores the heat maps H1 and H2 in the storage 105.

The estimation unit 1004 specifies a time zone in which the likelihood of the unit work is dominant, based on the smoothed time series of the likelihood, and estimates the work content of the work machine 3 in the time zone. For example, in a time zone in which the likelihood of the “excavation and loading”, which is unit work, is dominant, the work content of the work machine 3 is estimated to be the “excavation and loading”. Similarly, the estimation unit 1004 specifies a time zone in which the likelihood of the element work is dominant, based on the smoothed time series of the likelihood, and estimates the work content of the work machine 3 in the time zone. For example, in a time zone in which the likelihood of the “excavation”, which is element work, is dominant, the work content of the work machine 3 is estimated to be the “excavation”. The estimation unit 1004 stores information on the work content R estimated for the work machine 3 in the storage 105.

Returning to FIG. 5, subsequently, the reception unit 1001 receives a reproduction instruction (step S02). One aspect of the reproduction instruction may be an operation such as pressing a reproduction button. Further, the reproduction instruction may include information that serves as a starting point of reproduction, such as time, the position of the work machine 3, and various events such as occurrence of abnormality in the work machine 3.

Next, the reception unit 1001 of the CPU 100 receives a reproduction scene instruction for providing instructions on a reproduction scene (step S03).

Here, a procedure for the reception unit 1001 to receive the reproduction scene instruction for providing instructions on a reproduction scene will be described with reference to FIG. 10. When the reception unit 1001 receives the reproduction instruction in step S02, the reception unit 1001 refers to the storage 105 and acquires information on the work content R estimated for the work machine 3. As shown in FIG. 10, the reception unit 1001 displays as pop-up a list S1 of the unit work which is included in the estimated work content R on a display screen, based on the information on the estimated work content R, and causes the operator to select the unit work which is desired to be reproduced.

For example, if the operator selects the “excavation and loading” from the list S1, the reception unit 1001 displays as pop-up a list S2 of the element work which is included in the estimated work content R on the display screen, based on the information on the estimated work content R, and causes the operator to select the element which is desired to be reproduced. For example, if the operator selects the “excavation” from the list S2, the reception unit 1001 displays as pop-up an input screen S3 for inputting the work date and time on the display screen, and causes the operator to input the work date and time when reproduction is desired. Specifically, as shown in FIG. 10, the operator inputs the work date and time with numerical values of year-month-day and hour-minute-second. In a case where the selected unit work or element work does not exist at the input work date and time, or conflicts with the estimated work content R, the reception unit 1001 may cause the work date and time to be repeatedly input until a matching work date itself is input, or may use the closest work date and time in the estimated work content R as the input work date and time.

If the operator inputs the work date and time when reproduction is desired, the reception unit 1001 displays as pop-up a list S4 of the work machine identification information of the work machine 3 on the display screen and causes the operator to select the type of the work machine 3 which is desired to be reproduced. In the first embodiment, the case where the type of the work machine 3 is the work machine identification information is described. However, the type of the work machine 3 may be other information capable of identifying the work machine 3, such as a vehicle type and a model.

If the operator selects the type of the work machine 3 that is desired to be reproduced, the reception unit 1001 refers to the storage 105, displays as pop-up an input screen S5 of a 2D map showing map information on the display screen, and causes the operator to designate the work position of the work machine 3 which is desired to be reproduced. For example, the operator inputs the work position of the work machine 3 which is desired to be reproduced, by clicking a desired position on the input screen S5, or the like.

As described above, the reception unit 1001 receives the type of the work machine 3, the work content, the work date and time, and the work position as the reproduction scene instruction. The reception unit 1001 may receive information on the worker of the work machine 3, instead of the type of the work machine 3. In this case, information in which the information on the worker of the work machine 3 is associated with the type of the work machine 3 is stored in the storage 105 in advance, whereby it is possible to specify the type of the work machine 3 from the received worker information.

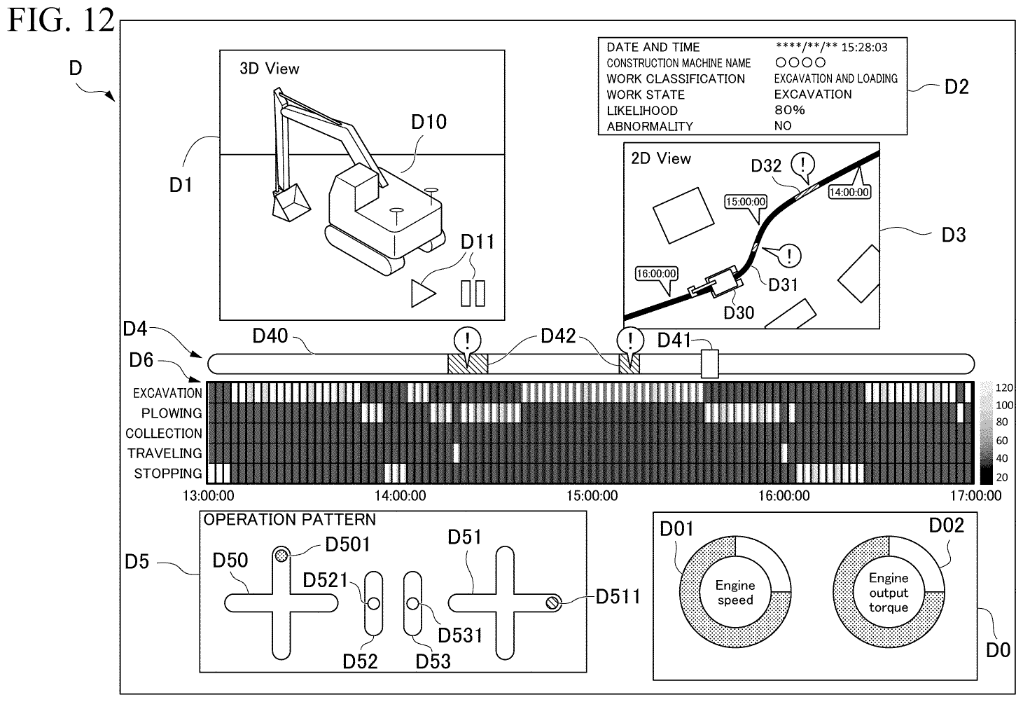

The procedure for receiving the reproduction scene instruction by the reception unit 1001 described using FIG. 10 is exemplification, and the reception unit 1001 may receive the reproduction scene instruction by, for example, another procedure. For example, in FIG. 10, the case where the lists S1, S2, and S4 and the input screens S3 and S5 are displayed as pop-up in order for the operator to select it has been described. However, display may be performed on a display image D, which will be described later in FIG. 12, to cause the operator to perform selection. Further, the reception unit 1001 may receive only some of information without receiving all the information on the type of the work machine 3, the work content, the work date and time, and the work position, and the order of receiving each information may also not be the order described above. For example, the reception unit 1001 may receive the work date and time, the work content, and the type of the work machine 3 in order.

Returning to FIG. 5, the acquisition unit 1000 of the CPU 100 selects and reads out the work machine model TM corresponding to the referenced work machine identification information from the storage 105, based on the work machine identification information as the type of the work machine 3 received by the reception unit 1001 (step S04).

Here, the work machine model TM will be described with reference to FIG. 11.

As shown in FIG. 11, the work machine model TM is information which includes the work machine identification information, an outer shape 3D model M0, an operating panel model M1, and the like of the work machine 3 indicated by the work machine identification information. The outer shape 3D model M0 is a 3D model representing the work machine 3 and is constructed for each of the parts of the work machine 3, such as the undercarriage and the upper swing body. For example, the outer shape 3D model M0 represents the shape of the work machine 3. For example, the outer shape 3D model M0 is composed of an undercarriage outer shape model M01 representing the undercarriage 31 of the work machine 3, an upper swing body outer shape model M02 representing the upper swing body 32, a boom outer shape model M03 representing the boom BM, an arm outer shape model M04 representing the arm AR, and a bucket outer shape model M05 representing the bucket BK.

The operating panel model M1 is a model representing the operating panel of the work machine 3 which is specified by the work machine identification information, and reproduces the input directions and the input degrees corresponding to the operating levers L1 and L2 and the traveling levers R1 and R2 by the operator of the work machine 3. Information indicating the correspondence between the operation types (rightward/leftward swing, arm excavation/dump, boom raising/lowering, bucket excavation/dump, right crawler forward movement/backward movement, and left crawler forward movement/backward movement (refer to FIG. 7)) of the work machine 3 and the input operation types (operating lever L1 front, operating lever L2 rightward direction, . . . ) of the operator of the work machine 3 is included in the operating panel model M1.

Returning to FIG. 5, the extraction unit 1002 of the CPU 100 extracts information to be used for reproduction, from the log information TL corresponding to the received type of the work machine 3, based on the type (work machine identification information) of the work machine 3 and the work content which are the reproduction scene instructions received by the reception unit 1001 (step S05). For example, various angle information such as a boom angle, an arm angle, and a bucket angle is extracted as the information to be used for reproduction. The pilot hydraulic pressure shown in FIG. 7 may be extracted as the information to be used for reproduction.

Subsequently, the CPU 100 draws a movement locus of the work machine 3 on a 2D map which is a bird's-eye view image of the work site with reference to the position of the work machine 3 at each time shown in the log information TL. For example, the movement locus of the work machine 3 is drawn while applying the position of the work machine 3 at each time shown in the log information TL onto the 2D map which is a bird's-eye view image of the work site in order from the oldest time stamp.

Here, the CPU 100 draws the movement locus of the work machine 3 from the position of the work machine 3 shown in the log information TL corresponding to the work date and time and the work position received as the reproduction scene instruction in step S03 onto a 2D map, which is a bird's-eye view image of the work site, in order from the oldest time stamp.

Further, the extraction unit 1002 refers to the status (FIG. 8) related to the drive mechanism such as the engine or the hydraulic pump of the work machine 3 at each time shown in the log information TL, and extracts a section in which abnormality has occurred in the drive mechanism (hereinafter, also referred to as an abnormality occurrence section) on the movement locus of the work machine 3. The CPU 100 draws the abnormality occurrence section over the movement locus on the display unit 102 (step S06). In another embodiment, the drawing processing in step S06 may be performed at the timing of step S07 (described later) or at a further subsequent step.

Next, the reproduction unit 1003 executes the animation reproduction processing of the work machine model TM (step S07). Here, the reproduction unit 1003 reproduces the operation of the work machine 3 from the reproduction scene which is specified by the received reproduction scene instruction. Specifically, the reproduction unit 1003 reproduces the work machine 3 by animation while applying various information recorded in the log information TL to the work machine model TM in order from the oldest time stamp from the work date and time received as the reproduction scene instruction. In a case where the reproduction instruction including various events is received in step S02, the work machine 3 is reproduced by animation while sequentially applying various information corresponding to the time when various events have occurred to the work machine model TM.

Specifically, the reproduction unit 1003 changes the angle of a corresponding portion of the outer shape 3D model M0, based on various angle information such as the swing angle and the boom angle shown in the log information TL. For example, the reproduction unit 1003 reproduces the position or posture of the bucket BK of the work machine 3 by tilting the bucket outer shape model M05 around a rotation axis which is defined at the connection position with the arm outer shape model M04 so as to have the bucket angle shown in the log information TL.

Similarly, the reproduction unit 1003 reproduces the position or posture of the arm AR of the work machine 3 by tilting the arm outer shape model M04 around a rotation axis which is defined at the connection position with the boom outer shape model M03 so as to have the arm angle shown in the log information TL.

Similarly, the reproduction unit 1003 reproduces the position or posture of the upper swing body 32 of the work machine 3 by tilting the upper swing body outer shape model M02 around a rotation axis which is defined at the connection position with the undercarriage outer shape model M01 so as to have the swing angle shown in the log information TL.

Similarly, the reproduction unit 1003 reproduces the posture of the upper swing body 32 of the work machine 3 by tilting the undercarriage outer shape model M01 around a roll rotation axis which is defined in the undercarriage outer shape model M01 so as to have the roll angle indicated by the log information TL and tilting the undercarriage outer shape model M01 around a pitch rotation axis which is defined in the undercarriage outer shape model M01 so as to have the pitch angle indicated by the log information TL.

Further, the reproduction device 10 according to the first embodiment can perform the animation reproduction of the traveling of the work machine 3, based on the PPC pressures of the right crawler forward movement/backward movement and the left crawler forward movement/backward movement at each time, which are included in the log information TL.

Specifically, the outer shape 3D model M0 is moved forward, retreated, moved forward to the left or the right, and retreated to the left or the right, based on the PPC pressures of the right crawler forward movement/backward movement and the left crawler forward movement/backward movement. For example, the outer shape 3D model M0 is moved in a front direction, based on the numerical values of the PPC pressures of the right crawler forward movement and the left crawler forward movement. The moving speed may be changed based on the numerical value of the PPC pressure.

Further, the outer shape 3D model M0 is moved in a rear direction, based on the numerical values of the PPC pressures of the right crawler retreat and the left crawler retreat. Further, the outer shape 3D model M0 is moved so as to turn in a curved manner in a front leftward or rightward direction, based on the difference between the numerical values of the PPC pressures of the right crawler forward movement and the left crawler forward movement. For example, in a case where the numerical value of the PPC pressure of the right crawler forward movement is larger than the numerical value of the PPC pressure of the left crawler forward movement, the outer shape 3D model M0 is moved so as to turn in a curved manner in a front leftward direction. The speed of the movement and the size of the curve may be changed according to the numerical values of the respective PPC pressures and the difference between the numerical values of the PPC pressures.

Similarly, the outer shape 3D model M0 is moved so as to turn in a curved manner in a rear leftward or rightward direction, based on the difference between the numerical values of the PPC pressures of the right crawler retreat and the left crawler retreat. For example, in a case where the numerical value of the PPC pressure of the right crawler retreat is larger than the numerical value of the PPC pressure of the left crawler retreat, the outer shape 3D model M0 is moved so as to turn in a curved manner in a rear leftward direction. The speed of the movement and the size of the curve may be changed according to the numerical values of the respective PPC pressures and the difference between the numerical values of the PPC pressures.

The traveling of the work machine 3 can be animated more accurately by performing reproduction by using the position information in addition to the PPC pressures of the right crawler forward movement/backward movement and the left crawler forward movement/backward movement. In this case, by using the position information, it is possible to more accurately express the speed of movement and position of the work machine 3. Further, by reproducing the work machine 3 by animation, based on the roll angle, the pitch angle, or both the roll angle and the pitch angle in addition to the PPC pressures of the right crawler forward movement/backward movement and the left crawler forward movement/backward movement, it is possible to reproduce the tilt in the left-right direction of the work machine 3 or the tilt in the front-rear direction of the work machine 3 during traveling.

Further, the reproduction unit 1003 performs animation reproduction of the input operations to various operating levers and the traveling levers by the operator of the work machine 3 by applying the PPC pressures of the operating levers L1 and L2 and the traveling levers R1 and R2 for each operation type, which are shown in the log information TL, to the operating panel model M1 of the work machine model TM in order from the oldest time stamp. The reproduction unit 1003 simultaneously performs the animation reproduction of the outer shape 3D model M0 and the operating panel model M1 on the same screen while aligning the reproduction times thereof with each other.

The reproduction unit 1003 determines whether or not to end the animation reproduction during the animation reproduction processing of the work machine 3 (step S08). For example, in a case where an instruction to end the reproduction is received based on pressing a stop button, or the like, it is determined that the animation reproduction is ended. It may be determined that the animation reproduction is ended after a predetermined period of time has elapsed after the start of the animation reproduction. In a case where the animation reproduction is not ended (step S08; NO), the reproduction unit 1003 continues the animation reproduction of the work machine model TM. On the other hand, in a case where the animation reproduction is ended (step S08; YES), the reproduction unit 1003 ends the animation reproduction processing.

Steps S00, S04, S05, S06, and S08 of the processing flow described using FIG. 5 are not essential configurations of the reproduction device 10, and another embodiment may not include such steps.

The example in which the reception unit 1001 receives the reproduction instruction and then receives the reproduction scene instruction before the animation reproduction of the work machine 3 has been described above. However, as another embodiment, a configuration may be made such that the reception unit 1001 receives the reproduction instruction and then receives the reproduction scene instruction during or after the animation reproduction of the work machine 3.

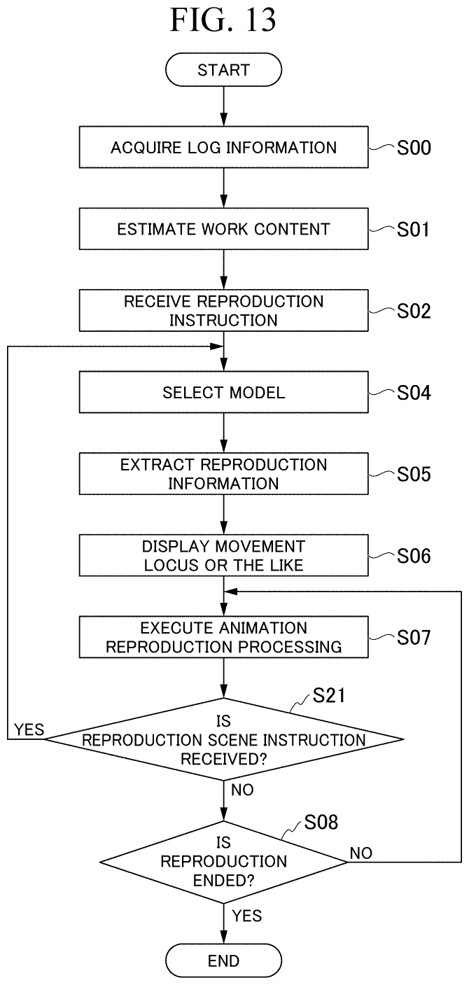

FIG. 13 shows a processing flow of the reproduction device in a case of receiving the reproduction scene instruction during the animation reproduction of the work machine 3. The processing flow according to a first other embodiment shown in FIG. 13 is different from the processing flow shown in FIG. 5 only in that there is no step S03 and instead, new step S21 exists between steps S07 and S08. Therefore, in the following, only the points different from those in the processing flow shown in FIG. 5 will be mainly described, and detailed description of the same processing as that in the processing flow shown in FIG. 5 will be omitted.

When the dedicated application is started by the operation of the operator, the acquisition unit 1000 of the CPU 100 loads and acquires all the log information TL to be reproduced, in the memory 101 (step S00). The estimation unit 1004 of the CPU 100 estimates the work content of the work machine 3 at each time, based on the acquired log information TL (step S01).

The reception unit 1001 of the CPU 100 receives the reproduction instruction (step S02). At this time, the reception unit 1001 of the CPU 100 receives the designation of the log information TL to be reproduced. The operator of the reproduction device 10 designates the log information TL to be reproduced, by inputting for example, a file name or the like of the log information TL. The log information TL to be reproduced may be fixed, and the designation of the log information TL may not be performed.

Subsequently, when the designation of the log information TL is received from the operator of the reproduction device 10 in step S02, the acquisition unit 1000 of the CPU 100 acquires the designated log information TL from among all the log information TL loaded in the memory 101. Next, the acquisition unit 1000 refers to the work machine identification information included in the log information TL. The acquisition unit 1000 selects and reads out the work machine model TM corresponding to the referred work machine identification information from the storage 105 (step S04). The designation of the work machine model TM may be fixed without selecting the work machine model TM.

Next, the extraction unit 1002 of the CPU 100 extracts information to be used for reproduction, from the log information TL (step S05). The CPU 100 draws the movement locus of the work machine 3 on a 2D map which is a bird's-eye view image of the work site, with reference to the position of the work machine 3 at each time shown in the log information TL.

Further, the extraction unit 1002 refers to the status (FIG. 8) related to the drive mechanism such as the engine or the hydraulic pump of the work machine 3 at each time shown in the log information TL, and extracts a section in which abnormality has occurred in the drive mechanism (hereinafter, also referred to as an abnormality occurrence section) on the movement locus of the work machine 3. The CPU 100 draws the abnormality occurrence section over the movement locus on the display unit 102 (step S06).

Next, the reproduction unit 1003 executes the animation reproduction processing of the work machine model TM (step S07). The reception unit 1001 determines whether or not the reproduction scene instruction has been received during the animation reproduction (step S21). When the reception unit 1001 receives the reproduction scene instruction (step S21; YES), the animation reproduction processing by the reproduction unit 1003 is interrupted, and the processing returns to step S04. Then, the read-out of the work machine model TM by the acquisition unit 1000 (step S04), the extraction of the information to be used for reproduction by the extraction unit 1002 (step S05), and the display of the movement locus or the like (step S07) are performed again based on the type of the work machine 3, the work content, the work date and time, the work position, and the like which are included in the received reproduction scene instruction. The reproduction unit 1003 executes the animation reproduction processing of the work machine model TM, and reproduces the operation of the work machine 3 from the reproduction scene which is specified by the received reproduction scene instruction (step S07).

On the other hand, when the reception unit 1001 does not receive the reproduction scene instruction (step S21; NO), the processing proceeds to step S08, and the reproduction unit 1003 determines whether or not to end the animation reproduction during the animation reproduction processing of the work machine 3 (step S08). In a case where the animation reproduction is not ended (step S08; NO), the reproduction unit 1003 continues the animation reproduction of the work machine model TM. On the other hand, in a case where the animation reproduction is ended (step S08; YES), the reproduction unit 1003 ends the animation reproduction processing.

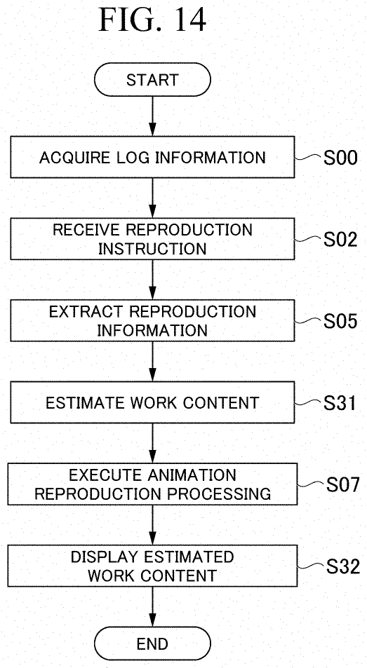

FIG. 14 shows a processing flow of a reproduction device according to a second other embodiment, which performs the minimum necessary processing for displaying the animation reproduction of the work machine 3 and the work contents estimated for the work machine 3. The processing flow shown in FIG. 14 is different from the processing flow shown in FIG. 5 only in that there is no steps S01, S03, S04, S06, and S08 and instead, new step S31 exists between steps S05 and S07 and that new step S32 exists after step S07. Therefore, in the following, only the points different from those in the processing flow shown in FIG. 5 will be mainly described, and detailed description of the same processing as that in the processing flow shown in FIG. 5 will be omitted.

When the dedicated application is started by the operation of the operator, the acquisition unit 1000 of the CPU 100 loads and acquires all the log information TL to be reproduced, in the memory 101 (step S00).

The reception unit 1001 of the CPU 100 receives the reproduction instruction (step S02). At this time, the reception unit 1001 of the CPU 100 receives the designation of the log information TL to be reproduced. The operator of the reproduction device 10 designates the log information TL to be reproduced, by inputting for example, a file name or the like of the log information TL. The log information TL to be reproduced may be fixed, and the designation of the log information TL may not be performed.

Subsequently, when the designation of the log information TL is received from the operator of the reproduction device 10 in step S02, the acquisition unit 1000 of the CPU 100 acquires the designated log information TL from among all the log information TL loaded in the memory 101.

Next, the extraction unit 1002 of the CPU 100 extracts information to be used for reproduction, from the log information TL (step S05). The estimation unit 1004 of the CPU 100 estimates the work content of the work machine 3 at each time, based on the acquired log information TL (step S31).

Next, the reproduction unit 1003 executes the animation reproduction processing of the work machine model TM (step S07). The CPU 100 displays the estimated work content on the display image D (step S32). Then, the processing flow shown in FIG. 14 ends. In the processing flow shown in FIG. 14, the case has described where the work content of the work machine 3 is estimated in step S31 and then the animation is reproduced in step S07. However, a configuration may be adopted in which the work content is estimated behind the scenes while reproducing the animation and displayed on the display screen D after the estimation is completed.

### (Display Screen of Reproduction Device)

FIG. 12 is a diagram showing an example of a display screen of the reproduction device according to the first embodiment.

The CPU 100 of the reproduction device 10 according to the first embodiment causes the display unit 102 to display a display image D as shown in FIG. 10, for example.

The display image D is configured to include an engine information image D0, an outer shape 3D model display image D1, an information list image D2, a 2D map image D3, a time scroll bar D4, an operation pattern image D5, and a heat map image D6.

The engine information image D0 is an area for presenting various information related to the engine of the work machine 3 to the operator of the reproduction device 10. The engine information image D0 includes, for example, an engine speed D01 and an engine output torque D02 which are displayed in an analog meter format such as a tachometer.

The outer shape 3D model display image D1 is an area in which the outer shape 3D model M0 is reproduced by animation. A work machine image D10 in which various information such as the boom angle, the arm angle, and the bucket angle showing the state of the work machine 3 is applied to the outer shape 3D model M0 (FIG. 9) is drawn on the outer shape 3D model display image D1. Further, a button image D11 for the operator of the reproduction device 10 to provide instructions on the animation reproduction, pause, or the like is drawn on the outer shape 3D model display image D1.

The information list image D2 is an area for presenting various information related to the reproduction to the operator of the reproduction device 10. The reproduction date and time, the vehicle type and model of the work machine model TM which is being reproduced, the estimated work content, the likelihood of the estimated work content, the presence or absence of abnormality at the reproduction time, and the like are included in the information list image D2. The character of information on a work classification and a work state which are the estimated work contents changes in conjunction with the animation reproduction on the outer shape 3D model display image D1. For example, in the case shown in FIG. 12, the work classification “excavation and loading” and the work state “excavation” are displayed in conjunction with the animation reproduction. However, when the work machine 3 displays the animation reproduction of a different work content, the work classification and work state corresponding to the work content are displayed.

The 2D map image D3 is an area in which a bird's-eye view image of the work machine 3 is drawn. In addition to the 2D map image which is a bird's-eye view image of the work site, a work machine icon D30, a movement locus D31, and an abnormality occurrence section D32 are drawn on the 2D map image D3. Further, on the 2D map image D3, the estimated work content R may be color-coded and drawn at a corresponding work position for each work content.

The work machine icon D30 is an image showing the position or direction on the 2D map of the work machine 3 which is being reproduced.

The movement locus D31 shows the movement locus of the work machine 3 in the 2D map. The work machine icon D30 and the movement locus D31 are drawn based on the position of the work machine 3 at each time included in the log information TL.

Further, the abnormality occurrence section D32 shows a section in which abnormality has occurred in the drive mechanism such as the engine or hydraulic pump of the work machine 3, of the movement locus D31. The abnormality occurrence section D32 is drawn based on the status (FIG. 8) of the drive mechanism of the work machine 3. For example, the CPU 100 extracts a section in which the engine cooling water temperature exceeds an abnormality determination threshold value defined in advance, of the movement locus D31 of the work machine 3, and draws the section as the abnormality occurrence section D32.

The operator of the reproduction device 10 may be able to change the reproduction time as desired, by performing an operation such as clicking, which designates a predetermined position on the movement locus D31, by using the operation reception unit 103 such as a mouse, for example.

The time scroll bar D4 is a scroll bar for controlling the animation reproduction. A bar image D40 showing the time axis from the start time to the end time, a reproduction time icon D41 corresponding to the time during the reproduction in the time axes shown by the bar image D40, and an abnormality occurrence time zone D42 are drawn on the time scroll bar D4. The reproduction time icon D41 is displayed at the position corresponding to the reproduction time in the bar image D40. The operator can change the reproduction time as desired, by performing an operation of sliding the reproduction time icon D41 on the bar image D40. In another embodiment, a configuration may be adopted in which the reproduction time is shown by changing a color of a location corresponding to the reproduction time of the heat map image D6, instead of the reproduction time icon D41, or a configuration may be adopted in which a line bar is displayed on the location corresponding to the reproduction time.

The abnormality occurrence time zone D42 is a time zone corresponding to the abnormality occurrence section D32 of the 2D map image D3, and shows a time zone in which abnormality has occurred in the drive mechanism of the work machine 3, from the start time to the end time.

The operator of the reproduction device 10 may be able to change the reproduction time as desired, by performing an operation of sliding the reproduction time icon D41 on the bar image D40 by using the operation reception unit 103.

The operation pattern image D5 is an area in which the input operation to the operating lever or the traveling lever by the operator of the work machine 3 is reproduced by animation. The operation pattern image D5 is composed of operation images D50, D51, D52, and D53 and operation icons D501, D511, D521, and D531.

Specifically, the operation image D50 is an area in which the input operation to the operating lever L1, which is the operating lever on the left side, is reproduced by animation. The position of the operation icon D501 on the operation image D50 indicates the input direction to the operating lever L1. Further, the color of the operation icon D501 which is displayed on the operation image D50 indicates the degree of input to the operating lever L1. For example, in a case where there is no input to the operating lever L1, the icon D501 is displayed in complete “white” and is displayed so as to change from “white” to “red” as the degree of input increases. The combination of colors that change according to the degree of input is not limited to this example. The same applies to the icons D511, D521, and D531 which will be described later.

The operation image D51 is an area in which the input operation to the operating lever L2, which is the operating lever on the right side, is reproduced by animation. The position of the operation icon D511 on the operation image D51 indicates the input direction to the operating lever L2. Further, the color of the operation icon D511 which is displayed on the operation image D51 indicates the degree of input to the operating lever L2.

The operation image D52 is an area in which the input operation to the traveling lever R1, which is the traveling lever on the left side, is reproduced by animation. The position of the operation icon D521 on the operation image D52 indicates the input direction to the traveling lever R1. Further, the color of the operation icon D521 which is displayed on the operation image D52 indicates the degree of input to the traveling lever R1.

The operation image D53 is an area in which the input operation to the traveling lever R2, which is the traveling lever on the right side, is reproduced by animation. The position of the operation icon D531 on the operation image D53 indicates the input direction to the traveling lever R2. Further, the color of the operation icon D531 which is displayed on the operation image D53 indicates the degree of input to the traveling lever R2.

The heat map image D6 is a map in which a color indicating the likelihood of the classification of the work is given to a plane in which the vertical axis represents the classification of the work and the horizontal axis represents time, and the unit work heat map H1 generated by the estimation unit 1004 is displayed on the display screen. The time on the horizontal axis of the heat map image D6 is displayed corresponding to the time which is displayed on the time scroll bar D4. As shown in FIG. 12, “excavation”, “plowing”, “collection”, “traveling”, and “stopping” indicating the classification of the work in each row are shown on the left side of the heat map image D6. Here, the “excavation”, the “plowing”, and the “collection” simply indicate “excavation and loading”, “plow removal”, and “load collection”, respectively. The relationship between the likelihood and the color is displayed on the right side of the heat map image D6.

In FIG. 12, the unit work heat map H1 is displayed as the heat map image D6. However, the element work heat map H2 may be displayed as the heat map image D6. Further, in FIG. 12, the heat map image D6 has a five-row configuration. However, it may have any row configuration according to the unit work or element to be displayed.

In FIG. 12, the case has been described where the display image D is configured to include the engine information image D0, the outer shape 3D model display image D1 on which animation is displayed, the information list image D2 displaying various information related to the reproduction, the 2D map image D3, the time scroll bar D4, the operation pattern image D5, and the heat map image D6. However, in another embodiment, there is no limitation to this. For example, the display image D may be configured to display only the animation and the character of the work classification or the work state. Further, the display image D may be configured to display only the animation and the heat map image D6. Further, the display image D may be configured to display only the animation, the heat map image D6, and the time scroll bar D4.

Further, in FIG. 12, the case has been described where the information list image D2 is configured to include the reproduction date and time, the vehicle type and model of the work machine model TM which is being reproduced, the estimated work content, the likelihood of the estimated work content, the presence or absence of abnormality at the reproduction time, and the like. However, in another embodiment, some of these information may be displayed on the information list image D2.

Further, in FIG. 12, the case has been described where the reproduction date and time, the vehicle type and model of the work machine model TM which is being reproduced, the estimated work content, the likelihood of the estimated work content, and the presence or absence of abnormality at the reproduction time are displayed on the information list image D2. However, some or all of these information may be displayed on the display image D1. For example, the information on the work classification and the work state which are the estimated work contents may be displayed on the display image D1 instead of the information list image D2. Further, either the work classification which is the estimated work content or the information on the work state may be displayed on the display image D1 instead of the information list image D2.

### Operation and Effects

As described above, the reproduction device 10 according to the first embodiment includes: the acquisition unit 1000 that acquires the log information TL of the work machine 3, which is associated with time; the reception unit 1001 that receives a reproduction instruction for the operation of the work machine 3; the reproduction unit 1003 that reproduces the operation of the work machine 3 by sequentially applying the angle information of the work machine 3 that is included in the log information TL to the work machine model TM, in a case of receiving the reproduction instruction, and the estimation unit 1004 that estimates a work content of the work machine 3 at each time, based on the log information TL.

By doing so, a series of operations performed by the work machine 3 at the actual work site are reproduced in the work machine model TM, based on the log information TL, and the work content of the work machine 3 that performs the series of operations is estimated. Therefore, it is possible to analyze the work by the operator of the work machine 3 in detail.

In particular, the log information TL which is used when the estimation unit 1004 estimates the work content includes information indicating the state of the work machine 3. In this way, it is possible to grasp the operation of the work machine 3 from the state of the work machine 3 and accurately estimate the work content of the work machine 3.

In particular, the log information TL which is used when the estimation unit 1004 estimates the work content includes information indicating the operation signal of the work machine 3. In this way, it is possible to grasp the operation of the work machine 3 from the operation signal of the work machine 3 and accurately estimate the work content of the work machine 3.

Further, in the reproduction device 10 according to the first embodiment, the reception unit 1001 receives the reproduction scene instruction for providing instructions on the reproduction scene, and the reproduction unit 1003 reproduces the operation of the work machine 3 from the reproduction scene which is specified by the reproduction scene instruction. In this way, the operation of the work machine 3 at the actual work site which the operator desires to reproduce can be designated in detail, and therefore, it is possible to efficiently analyze the work performed by the operator of the work machine 3 at the work site.

Further, in the reproduction device 10 according to the first embodiment, the reproduction scene instruction includes information on any one of at least the type of the work machine 3, the work content, the work date and time, the work position, and the worker. In this way, it is possible to analyze in detail the work performed by the operator of the work machine 3 at the work site by classifying it into any one of the type of the work machine 3, the work content, the work date and time, the work position, and the worker, or a combination thereof. Further, the operation of the work machine 3 at the actual work site which the operator desires to reproduce can be designated in detail, and therefore, it is possible to efficiently analyze the work performed by the operator of the work machine 3 at the work site.

Further, the reproduction device 10 according to the first embodiment displays the work content estimated by the estimation unit 1004 on the display unit 102. In this way, it is possible to analyze the correspondence relationship between the work content of the work machine 3 and the movement of the work machine 3.

In particular, the reproduction device 10 according to the first embodiment displays the work content estimated by the estimation unit 1004 to correspond to the time during the reproduction. In this way, the correspondence relationship between the work content of the work machine 3 and the movement of the work machine 3 can be analyzed in detail in association with the passage of time.

In particular, the reproduction device 10 according to the first embodiment displays only the work contents whose likelihood is equal to or higher than a predetermined threshold value, among the work contents estimated by the estimation unit 1004. In this way, inaccurate information can be removed, and it is possible to accurately analyze the work performed by the operator of the work machine 3 at the work site.

Further, the reproduction device 10 simultaneously reproduces the outer shape 3D model and the operating panel model M1 while aligning the reproduction times thereof with each other, and displays the work content at the reproduction time. By doing so, it is possible to analyze the correspondence relationship between the input operation by the operator for a predetermined work content and the appearance movement of the work machine 3 based on the input operation.

Further, the reproduction device 10 reproduces the animation of the work machine 3 in the outer shape 3D model display image D1, shows the reproduction time in the time scroll bar D4, and further displays the heat map in the heat map image D6. By doing so, it is possible to grasp not only a series of operations which are being currently reproduced but also the contents of a series of operations which will be performed by the work equipment 3 in the future by the heat map, and therefore, it is possible to confirm a series of operations actually performed by the work machine 3 at the work site while grasping a series of operations that the work equipment 3 will perform next.

Further, the reproduction device 10 according to the first embodiment extracts the abnormality occurrence time zone showing the time zone in which the state of the work machine 3 has become abnormal, from the log information TL, and displays it on, for example, the time scroll bar D4 or the like and displays the work content corresponding to the abnormality occurrence time zone in the heat map image D6. In this way, the operator of the reproduction device 10 can easily grasp the relationship between the time zone in which abnormality has occurred in the work machine 3 and the work content.

Further, the reproduction device 10 according to the first embodiment reproduces a change in the position of the work machine 3 on the two-dimensional map and displays the work content corresponding to each time. By doing so, it is possible to grasp in detail the correspondence between the change in the position of the work machine 3 at the work site and the work content.

Further, the reproduction device 10 displays the section in which abnormality has occurred in the work machine 3 on the movement locus D31. By doing so, it is possible to analyze at what position and work content in the work site the abnormality has occurred.

The reproduction device 10 according to another embodiment receives the reproduction instruction and then receives the reproduction scene instruction during or after the animation reproduction of the work machine 3. By doing so, the operator can visually confirm the display image D which is displayed on the display screen of the reproduction device, and therefore, it becomes very easy to provide instructions on the reproduction scene which is desired to be reproduced.

The reproduction device 10 according to the first embodiment and the analysis assistance system 1 provided with the reproduction device 10 have been described in detail above. However, in another embodiment, there is no limitation to the above-aspects.

The contents (FIGS. 6 to 8) of the log information TL according to the first embodiment are not limited to these in another embodiment. For example, in a case where the work machine 3 is not a hydraulic excavator but another vehicle type, the log information TL corresponding to the vehicle type is recorded. Another vehicle type is, for example, a wheel loader or the like.

Similarly, as the work machine model TM according to the first embodiment, a work machine model representing the outer shape and operating panel of the work machine 3 is prepared for each vehicle type or model of the work machine 3.

Further, the example has been described in which the log information TL according to the first embodiment includes the position of the work machine 3, the angles of various movable parts (FIG. 6), the PPC pressures in the operating mechanisms (FIG. 7), and the status of the drive mechanism (FIG. 8) of the work machine 3 at each time. However, in another embodiment, there is no limitation thereto.

The reproduction device 10 according to another embodiment may acquire only the information in FIG. 6 as the log information TL. In this case, the reproduction device 10 reproduces only the operation of the work machine 3 by animation, based on the log information TL. Further, the reproduction device 10 may acquire only the information in FIG. 7 as the log information TL. In this case, the reproduction device 10 can performs animation reproduction of the traveling of the work machine 3 and the input operations to various operating levers and traveling levers of the work machine 3, based on the log information TL.

Further, the reproduction device 10 according to the first embodiment has been described as including both the outer shape 3D model M0 and the operating panel model M1 as the work machine model TM and reproducing both the outer shape 3D model M0 and the operating panel model M1. However, in another embodiment, there is no limitation to this aspect. The reproduction device 10 according to another embodiment may reproduce only one of the outer shape 3D model M0 and the operating panel model M1 in the work machine model TM including either the outer shape 3D model M0 or the operating panel model M1. Further, the reproduction device 10 may be an aspect in which whether to reproduce the outer shape 3D model M0 or the operating panel model M1 can be changed by setting.

Further, the reproduction device 10 according to the first embodiment has been described as reproducing a change in the position of the work machine 3 on the 2D map. However, in another embodiment, there is no limitation to this aspect. The reproduction device 10 according to another embodiment may be an aspect in which a change in the position of the work machine 3 on the 2D map is not reproduced.

Further, the reproduction device 10 according to the first embodiment has been described as displaying the abnormality occurrence section on the 2D map and the abnormality occurrence time zone on the time scroll bar. However, in another embodiment, there is no limitation to this aspect. The reproduction device 10 according to another embodiment may be an aspect in which the abnormality occurrence section on the 2D map or the abnormality occurrence time zone on the time scroll bar is not displayed.

Further, the reproduction device 10 according to another embodiment may have not only normal speed reproduction but also fast forward, slow reproduction, repeat, and rewind functions.

For example, in a case of performing reproduction using 15 pieces of angle information or the like per second in the normal reproduction, the reproduction unit 1003 realizes a double-speed fast-forward function by performing reproduction using 30 pieces of angle information or the like per second, or by skipping 15 pieces of angle information or the like per second. A fast-forward function of triple-speed or the like can also be realized by the same mechanism.

Similarly, in a case of performing reproduction using 15 pieces of angle information or the like per second in the normal reproduction, the reproduction unit 1003 realizes a slow reproduction function of ½ times speed by reproducing 15 pieces of angle information or the like over 2 seconds. In particular, by enabling slow reproduction of the operation pattern image D5 (FIG. 12), a trainee can grasp the lever operation technique of an expert in more detail.

Similarly, in the normal reproduction, in a case of performing reproduction by sequential application from the oldest time stamp, the rewind reproduction is realized by performing reproduction by sequential application from the newest time stamp.

Further, in the operating mechanisms such as the operating levers L1 and L2 and the traveling levers R1 and R2 according to the first embodiment, the degree of input to each operating mechanism has been described as being expressed by the PPC pressure. However, in another embodiment, there is no limitation to this aspect.

For example, the operating mechanism according to another embodiment may be an electric operating mechanism. In this case, various operating mechanisms may have an operating member such as an electric lever, and an operating amount sensor such as a potentiometer inclinometer that electrically detects the tilt amount of the operating member. In this embodiment, the detection data of the operating amount sensor is recorded in the data logger 20.

Further, the reproduction device 10 according to the first embodiment has been described as representing the work machine 3 with the outer shape 3D model M0. However, in another embodiment, there is no limitation to this aspect. The reproduction device 10 according to another embodiment may represent the work machine 3 with a 2D model, for example.

Further, the reproduction device 10 according to the first embodiment has been described as expressing the degree of input by the operating mechanism of the operator with a change in color of the icon D501 or the like, which is shown in the operation pattern D5. However, in another embodiment, there is no limitation to this aspect. For example, the reproduction device according to another embodiment may express the degree of input with a position where the icon D501 or the like is drawn. For example, in the reproduction device 10, in a case where the degree of input to the operating lever L1 is small, the icon D501 or the like is drawn at a position close to the center of the operation image D50, and the icon D501 or the like is drawn at a position farther from the center of the operation image D50 as the degree of input to the operating lever L1 increases.

Further, in another embodiment, the degree of input may be shown by the strength of gradation of a color which is drawn in the operation image D50.

Further, the reproduction device 10 according to the first embodiment has been described as being installed at a place away from the work machine 3 and being connected to the data logger 20 mounted on the work machine 3 through a wide area communication network. However, in another embodiment, there is no limitation to this aspect.

For example, in the reproduction device 10 according to another embodiment, a part or the whole configuration of the reproduction device 10 may be installed inside the work machine 3. In this case, the data logger 20 may transmit the log information TL to the reproduction device 10 through a network or the like inside the work machine 3 without going through the wide area communication network. By doing so, the operator who boards the work machine 3 can confirm the movement of the work machine 3 which is operated by the operator himself by animation reproduction on the spot. Further, by reproducing the movement of the work machine 3, which becomes a model for the operator of the work machine 3, it can be used as guidance.

The reproduction device 10 installed inside the work machine 3 may acquire the log information TL of the other work machine 3 through the wide area communication network or the like. By doing so, it is possible to perform animation reproduction of the state of the work machine 3 other than the work machine 3 on which the reproduction device 10 is mounted.

Further, the reproduction device 10 according to another embodiment may be an aspect in which the reproduction device 10 is installed at a place away from the work machine 3 and video information generated by the animation reproduction processing is transmitted to and displayed on a monitor mounted on the work machine 3.

Further, in another embodiment, as one aspect of the reproduction instruction which is received from the operator, the position of the work machine 3 shown on the screen on the 2D map may be designated. In this case, the reproduction device 10 performs the reproduction of the work machine 3 with the time when the work machine 3 exists at the position designated by the operator as the reproduction start time.

Further, in another embodiment, as one aspect of the reproduction instruction which is received from the operator, for example, a reproduction period may be designated. For example, the reproduction period may be a reproduction start time and a reproduction end time. In this case, the reproduction device 10 performs the reproduction of the work machine 3 in the received reproduction period. Further, in another embodiment, the designation of the reproduction end time is not essential. For example, in another embodiment, an aspect may be adopted in which as the reproduction instruction from the operator, only the reproduction start time is received and reproduction is performed for a certain period of time from the reproduction start time, or an aspect may be adopted in which the reproduction is continued as long as the log information exists, or the reproduction may be stopped when various other events occur.

The log information TL (FIGS. 6 to 8) to be acquired does not need to be arranged in chronological order. In this case, the reproduction unit 1003 only needs to apply the information to be used for reproduction, of the log information TL, to the work machine model TM in chronological order.

The display unit according to the first embodiment displays the work content estimated by the estimation unit 1004 as the heat map image D6. However, in another embodiment, there is no limitation to this. For example, the work content estimated by the estimation unit 1004 may be displayed only with character information. Specifically, the work content estimated by the estimation unit 1004 may be displayed only with character information such as “excavation and loading: excavation” to correspond to the time during the reproduction.

Various processing processes of the reproduction device 10 described above are stored in a computer-readable recording medium in the form of a program, and a computer reads and executes this program, whereby various processing described above is performed. Further, the computer-readable recording medium refers to a magnetic disk, a magneto-optical disk, a CD-ROM, a DVD-ROM, a semiconductor memory, or the like. Further, this computer program may be distributed to a computer by a communication line, and the computer received the distribution may execute the program.

The above program may be a program for realizing some of the functions described above. Further, it may be a so-called difference file, a difference program, or the like, which can realize the functions described above in combination with a program already recorded in a computer system.

Although some embodiments of the present invention have been described above, these embodiments have been presented as examples and are not intended to limit the scope of the invention. These embodiments can be implemented in various other forms, and various omissions, replacements, and changes can be made within a scope which does not depart from the gist of the invention. These embodiments or modifications thereof are included in the scope or gist of the invention as well as in the scope of the invention described in the claims and the equivalent scope thereof.

According to the reproduction device described above, it is possible to reproduce the operation of the work machine that is a target and estimate the work content to accurately analyze the movement of the work machine.

1. A reproduction device comprising:
an acquisition unit configured to acquire log information of a work machine, which is associated with time;
a reception unit configured to receive a reproduction instruction for an operation of the work machine;
a reproduction unit configured to reproduce the operation of the work machine, by sequentially applying angle information of the work machine that is included in the log information, to a work machine model in a case of receiving the reproduction instruction; and
an estimation unit configured to estimate a work content of the work machine at each time, based on the log information.

2. The reproduction device according to claim 1, wherein
the log information includes information indicating a state of the work machine.

3. The reproduction device according to claim 1, wherein
the log information includes information on an operation signal of the work machine.

4. The reproduction device according to claim 1, wherein
the reception unit is configured to receive a reproduction scene instruction for providing instructions on a reproduction scene, and
the reproduction unit is configured to reproduce the operation of the work machine from the reproduction scene that is specified by the reproduction scene instruction.

5. The reproduction device according to claim 4, wherein
the reproduction scene instruction includes information on at least any one of a type of the work machine, a work content, a work date and time, a work position, and a worker.

6. The reproduction device according to claim 1, wherein
the work content estimated by the estimation unit is displayed on a display unit.

7. The reproduction device according to claim 6, wherein
the work content estimated by the estimation unit is displayed corresponding to time during reproduction.

8. The reproduction device according to claim 6, wherein
only the work content with a likelihood equal to or higher than a predetermined threshold value, of the work contents estimated by the estimation unit, is displayed.

9. An analysis assistance system comprising:
an acquisition unit configured to acquire log information of a work machine, which is associated with time;
a reception unit configured to receive a reproduction instruction for an operation of the work machine;
a reproduction unit configured to reproduce the operation of the work machine from the log information in a case of receiving the reproduction instruction; and
an estimation unit configured to estimate a work content of the work machine at each time, based on the log information.

10. A reproduction method comprising:
acquiring log information of a work machine, which is associated with time;
receiving a reproduction instruction for an operation of the work machine;
reproducing the operation of the work machine from the log information in a case of receiving the reproduction instruction; and
estimating a work content of the work machine at each time, based on the log information.
